(19) United States
(12) Patent Application Publication
(10) Pub. No.: US 2015/0055330 A1
(43) Pub. Date: Feb. 26, 2015

(54) Solar Lantern Lamp having LED Candel

(71) Applicant: Test Rite International Co., Ltd., Taipei (TW)

(72) Inventor: Jichang Xu, Shenzhen (CN)

(73) Assignee: Test Rite International Co., Ltd., Taipei (TW)

(21) Appl. No.: 13/972,192

(22) Filed: Aug. 21, 2013

(51) Int. Cl. F21L 4/00

(52) U.S. Cl. CPC F21L 4/00
USPC 362/183

(57) ABSTRACT

A solar lighting system comprises a candle lantern lamp and a solar charging basket. The candle lantern lamp comprises a LED lamp having a candle shaped cover, enclosed in a housing; a slide on/off switch on the bottom of the LED lamp, a build-in rechargeable battery, a PCB controller for charging by the solar panel and prevent over charging, and a pair of contact pins connecting the charging base with the LED lamp and supplying solar energy to the rechargeable battery. The charging basket comprises a base and a handle, wherein a solar panel is permanently installed on the handle and the based provides at least two charging rings coupled with the base of the LED lamp.

### BACKGROUND

1. Technical Field

This disclosure is related to a solar charged LED lamp, and more particularly to a solar LED lamp in residential use.

2. Description of the Related Art

Appliances, lighting and electronics accounted for about 35% total energy consumption in a US household, according to a survey published by Department of Energy of United States in 2009. More energy efficient solutions are needed for energy conservation.

LEDs offer higher power efficiency and longer life time, and have rapidly replaced incandescent light bulbs in residential lighting applications. Further, solar powered LEDs are even better substitutes than conventional light bulbs in specialty lighting, such as decorative lighting and safety lighting.

The present invention disclosed herein is an LED based lighting system that is powered by solar energy.

### SUMMARY OF THE INVENTION

The present invention is directed to a solar lighting system, comprising a solar panel, converting solar energy to charge a rechargeable battery; a detachable lamp, comprising an LED, electrically connected to the rechargeable battery; and a carrying vessel. In the solar lighting system, the rechargeable battery is placed on the base of the detachable lamp and the solar panel is permanent attached to at least one outer surface of the carrying vessel; the carrying vessel is substantially hollow to allow the detachable lamp to easily enter and exit from the carrying vessel; and the when the lamp is placed inside the carrying vessel, the lamp is substantially exposed to the environment where the system resides.

The present invention allows the solar LED lamp to be charged by solar power in sunlight or environmental light during the day and to emit light in night time.

In one aspect of the present invention, the solar lamp is substantially lantern shaped, having plastic housing defining plurality of windows.

In another aspect of the present invention, the solar lamp is detachable from the solar lighting system.

In another aspect of the present invention, the LED employed in the lantern lamp has a cover substantially candle shaped.

In another aspect of the present invention, the lighting system comprises a carrying vessel, in a shape substantially like a basket. The basket can accommodate two, three or four lantern lamps.

### BRIEF DESCRIPTION OF THE DRAWINGS

Exemplary embodiments of the disclosure will be more clearly understood from the following detailed description taken in conjunction with the accompanying drawings in which:

FIG. 1 illustrates a perspective view of one embodiment of a solar lighting system, in accordance with aspects of the present invention;

FIG. 2 illustrates an exploded view of one embodiment of a solar lamp and a solar charging basket, in accordance with aspects of the present invention;

FIGS. 3a-b illustrate an exploded view of one embodiment of a solar lamp in an exemplary solar lighting system, in accordance with aspects of the present invention;

FIG. 4 illustrates an exploded view of one embodiment of a solar lamp and a solar charging seat in an exemplary solar lighting system, in accordance with aspects of the present invention;

FIG. 5 is a circuit diagram of the control circuits of the solar lighting system, in accordance with aspects of the present invention;

FIG. 6 is a schematic diagram of an exemplary solar LED lighting system;

FIG. 7 is a schematic diagram of the working principle of an exemplary solar LED lighting system;

FIG. 8 illustrates a perspective view of an exemplary solar lighting system, wherein the system has two lantern lamps in the charging basket;

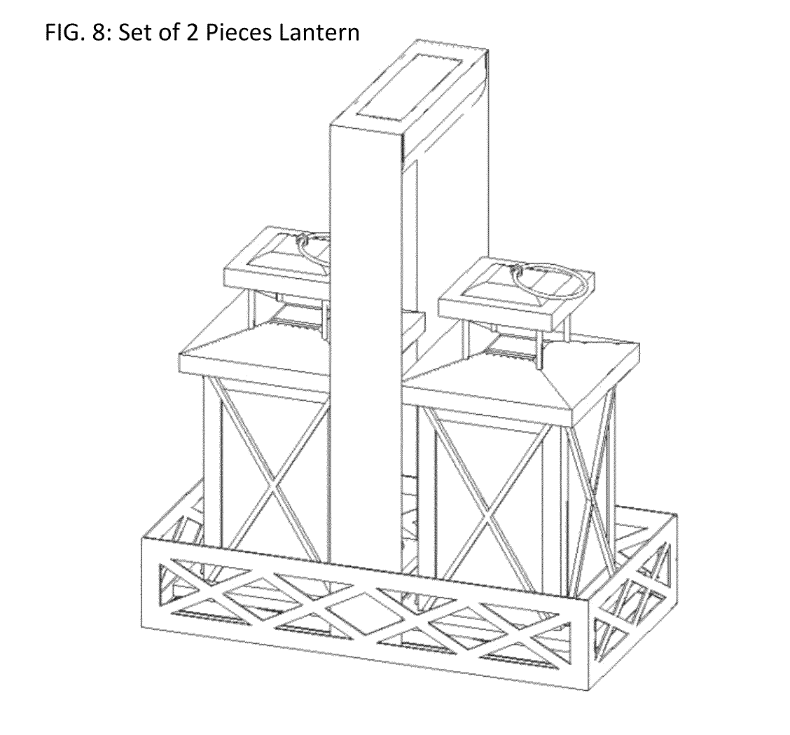

FIG. 9 illustrates a perspective view of an exemplary solar lighting system, wherein the system has four lantern lamps in the charging basket;

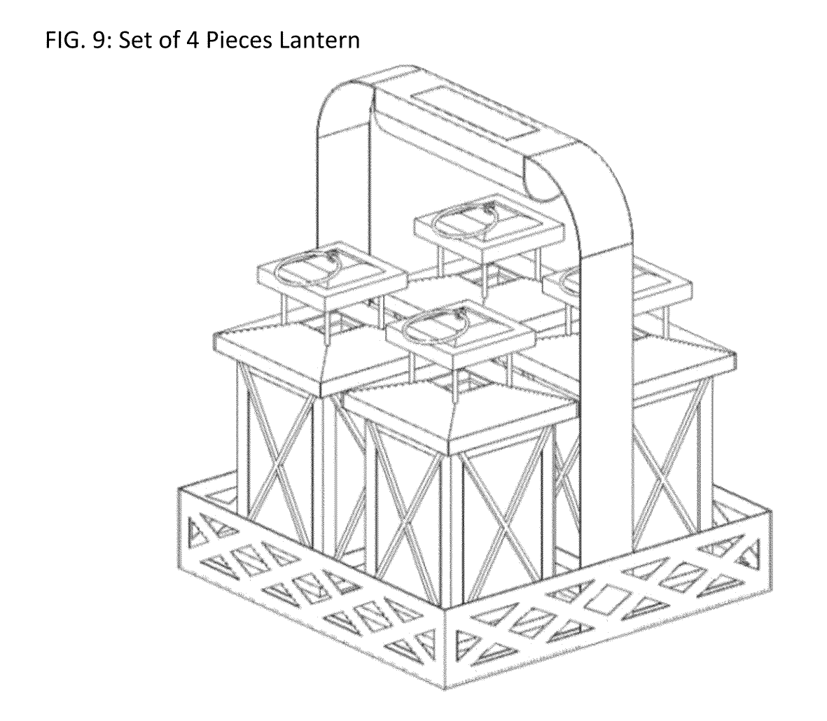

FIG. 10 is a perspective view of a lantern lamp in emission mode, in accordance with the aspects of the present invention;

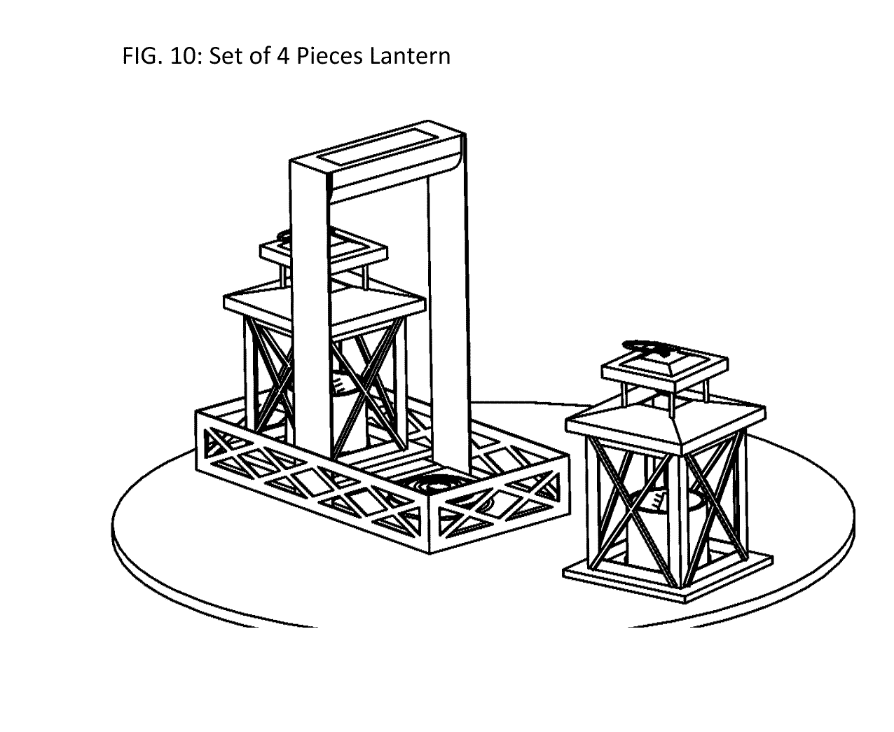

FIG. 11 is a perspective view of a lantern lamp in de-attached emission mode, in accordance with the aspects of the present invention;

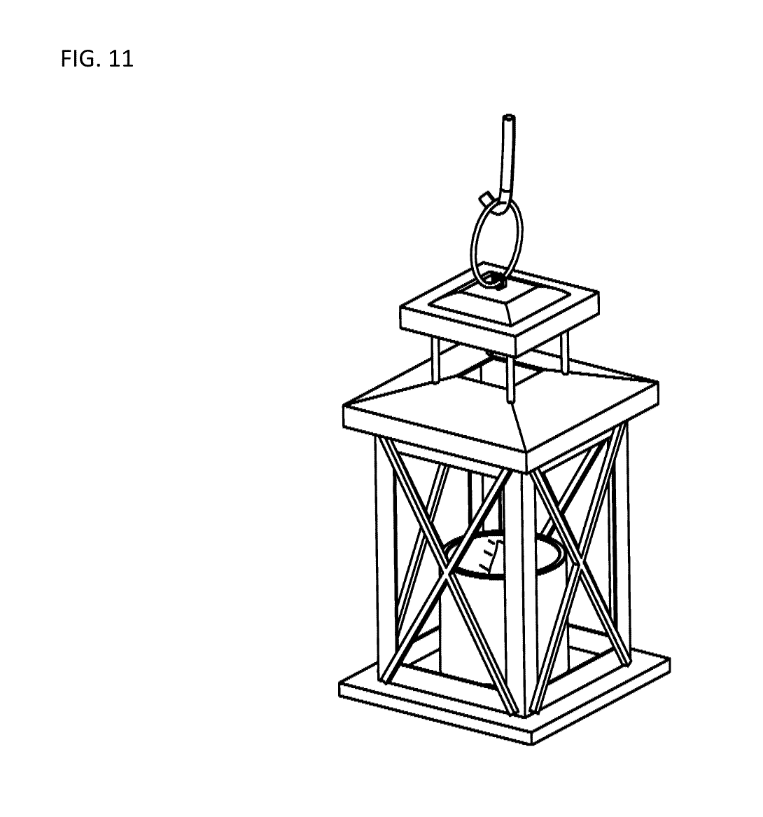

### DETAILED DESCRIPTION OF SELECTED EXAMPLES

Hereinafter, selected examples of solar lighting systems will be discussed in the following with reference to the accompanying drawings. It will be appreciated by those skilled in the art that the following discussion is for demonstration purposes, and should not be interpreted as a limitation. Other variances within the scope of this disclosure are also applicable.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the term “embodiments of the invention” does not require that all embodiments of the invention include the discussed feature, advantage or mode of operation.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation. Moreover, it is to be appreciated that the drawings may not be to scale.

“Optional” or “optionally” means that the subsequently described circumstance may or may not occur, so that the description includes instances where the circumstance occurs and instances where it does not.

In the scope of the present invention, solar lamp, LED lamp and lantern lamp are all used to refer to the lighting elements that can be accommodated in the charging basket. LED candle is used to refer to the light emitting diode and the candle shaped cover. LED lamp means LED candle lantern lamp refers to the light element accommodated in the charging basket, having a lantern shaped housing and candle shaped LED cover inside the housing. Element 3 is an exemplary lantern lamp and element 6 is an exemplary candle LED. LED 10 is used to refer the lighting emitting diode.

In the figures, the following reference numerals are utilized with the respective elements:
1 Solar panel
2 Handle
3 Lantern lamp
4 Charging basket
5 Charging base/charging seat
6 LED candle
7 Charging ring
8 Charging fixture
9 Contact pin
10 LED
11 PCB
12 Rechargeable battery
13 Slide ON/OFF switch
14 Charging ring (+)
15 Charging ring (−)

Described herein is a solar LED lighting system and method of operation. The solar LED lighting system provides energy efficient lighting solutions in residential applications. The solar LED lighting system is a self-sustained system, wherein the system is charged by solar energy during the day, and lights up at the night.

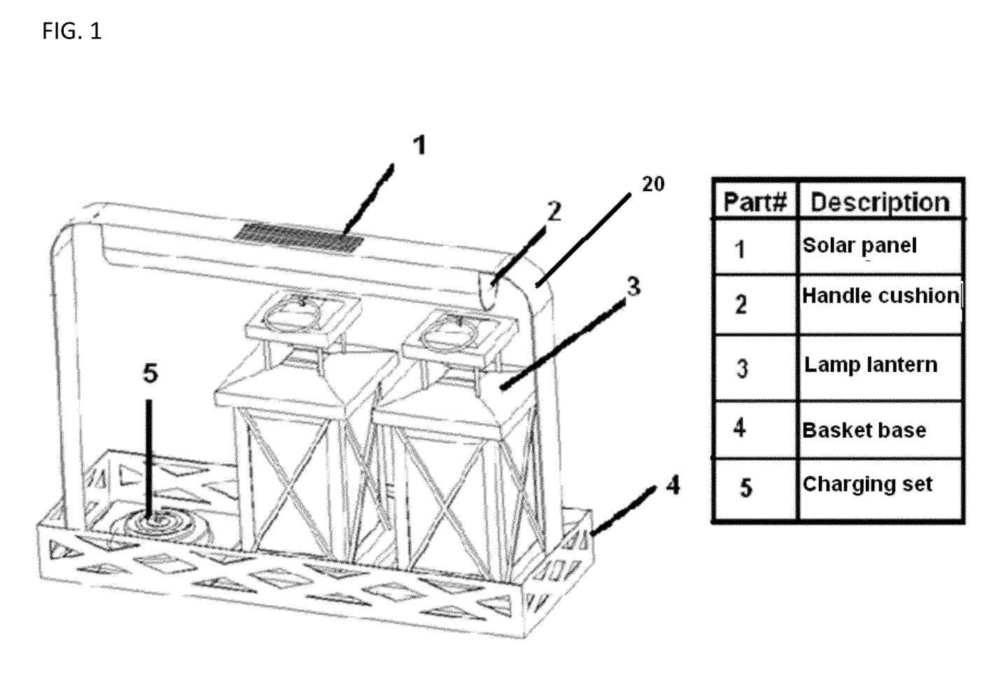

The solar LED system comprises at least an LED lamp 3 and a carrying vessel. Referring to FIG. 1, one or more LED lamps 3 are placed on the charging seats 5 inside of the carrying vessel. The LED lamp comprises at least one LED and a rechargeable battery. The carrying vessel comprises a base, a handle and a solar panel. The solar panel absorbs light energy and converts it to electrical energy to charge the rechargeable battery, which in turn powers the LED lamp.

The carrying vessel can have a wide choice of colors, sizes, patterns, and details. In accordance with the aspects of the present invention, the carrying vessel has to meet certain decorative and storage requirements for the solar lighting system. The carrying vessel has to be open and without a lid so that the lighted LED light can be enjoyed without being taken out of the carrying vessel. The carrying vessel can be made of any material as long as the material offers substantial structure integrity and mechanical strength to hold the LED lamps.

In one embodiment, the carrying vessel is substantially basket shaped, having a basket shaped base and basket like handle. The basket base can be any shape, as long as the base can accommodate the desired number of LED lamps and the base has reasonable aesthetical value. In one example, the basket base is rectangular shaped having two long sides and two short sides. In another example, the basket base is square shaped. The charging seats are placed next to each other in the basket base.

The basket handle, shown in FIG. 1, is substantially inverted U shaped, having two perpendicular bars and one horizontal cross over bar. The two perpendicular bars are attached to opposite sides of the basket base.

The solar panel in the charging basket can be affixed to any surface substantially exposed to sunlight. In one example, the solar panel 1 is permanently attached to the surface of the horizontal bar of the inverted U-shaped handle. Optionally, the solar panel can be attached the surface of the perpendicular bars.

The solar panel attached to the charging basket, can be any shape. In one example, the solar panel has the same geometry as that of the handle.

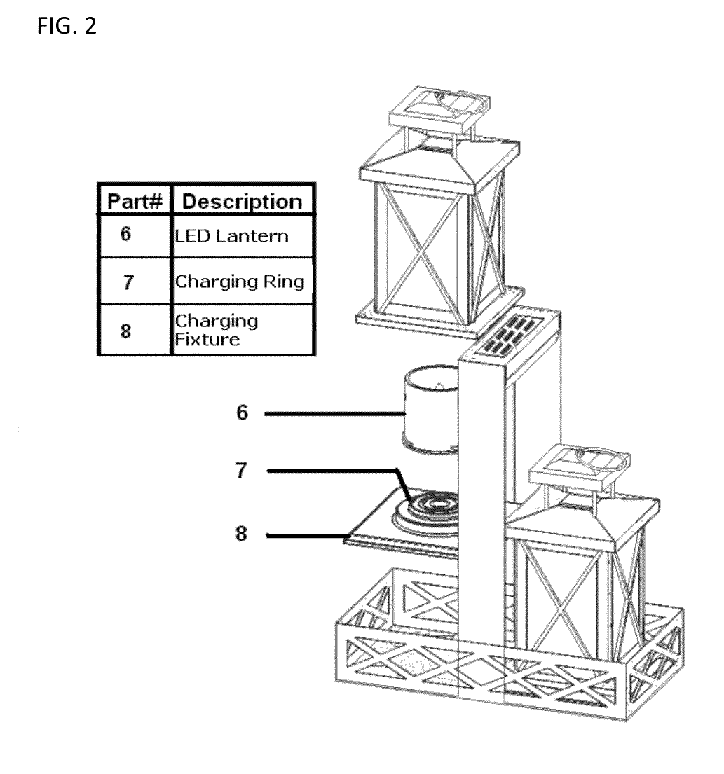

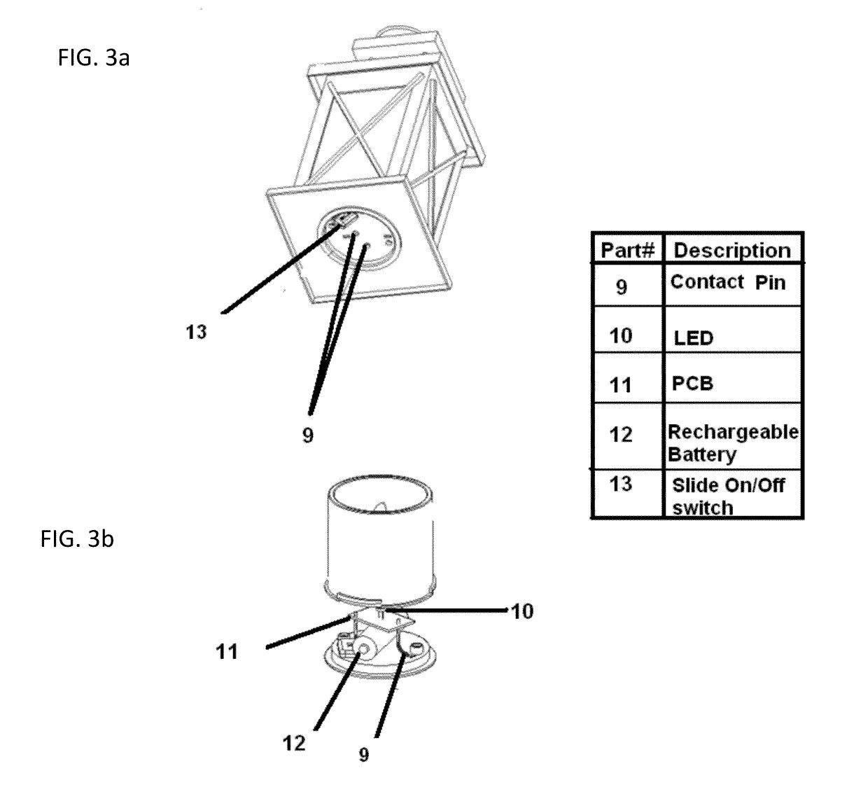

FIG. 2 and FIGS. 3a-b are exploded views of the LED lamp and the solar lighting assembly. As shown in FIG. 2, the LED 6 is placed in a housing, and sits on a charging seat consisting essentially of charging rings and a charging fixture. The LED lamps are placed on the charging seats, preferably through a locking mechanism, wherein the inner diameter of the base of the LED lamp is greater than the diameter of the top ring of the charging seat.

In one example, the lighting element (6) inside the solar lamp (3) is candle shaped. In another example the LED lamp (3) comprises a housing, wherein the housing defines a plurality of windows, allowing the emission from the lighting element 6 to transmit through the housing.

In one embodiment, the LED lamp 3 comprises a rechargeable battery 12. Preferably, as shown in FIG. 3b, the rechargeable battery 12 is placed on the bottom of the lamp 3. The LED lamp further comprises a PCB 11 with a control circuit. The LED lamp 3 further has two contact pins 9, electrically connecting the LED lamp with the charging seat when the lamp is placed on the charging seat.

The LED lamp 3 further comprises a slide switch 13. The slide switch is a 2-level ON/OFF switch. The external switch and the controller on the PCB 11 are integrated together to control the illumination state of the LED candle.

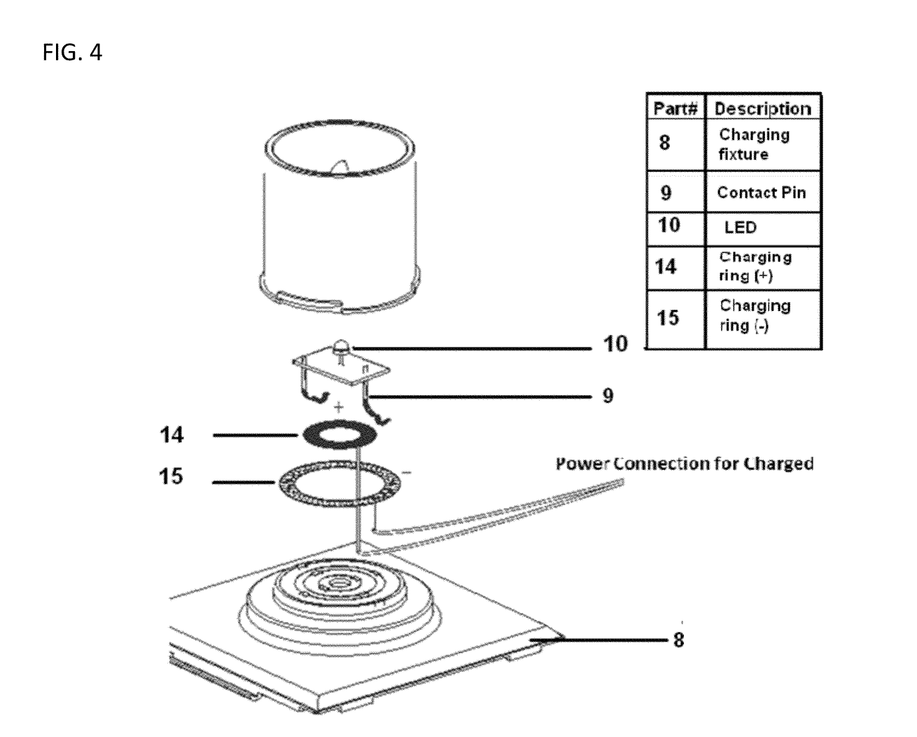

Referring to FIG. 4, the LED candle 6 further comprise of a candle shaped lamp cover and light emitting diode 10. The two contact pins can connect with the positive charging ring and negative charging ring on the charging fixture during the charging process by the solar panel.

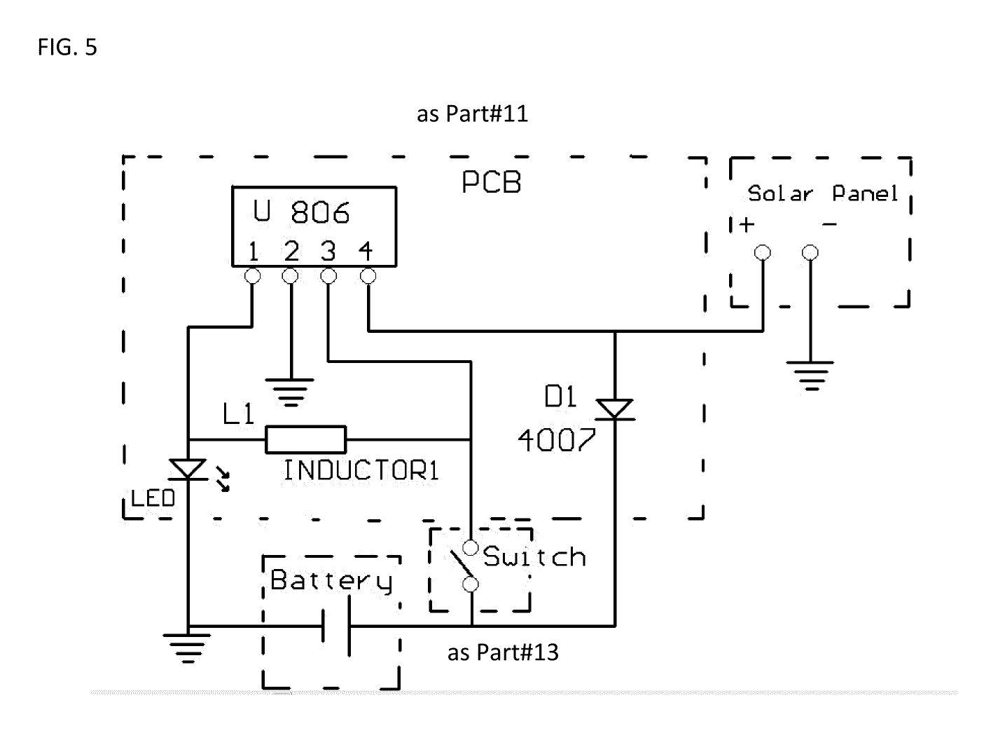

FIG. 5 illustrates the circuit diagram of the solar LED system in accordance with the present invention. The LED 10 is powered by the battery 12 and controlled by the manual switch 13. The battery is charged by the solar panel. All components, LED 10, battery 12, switch 13 and solar panel 1 are connected with the PCB controller 11.

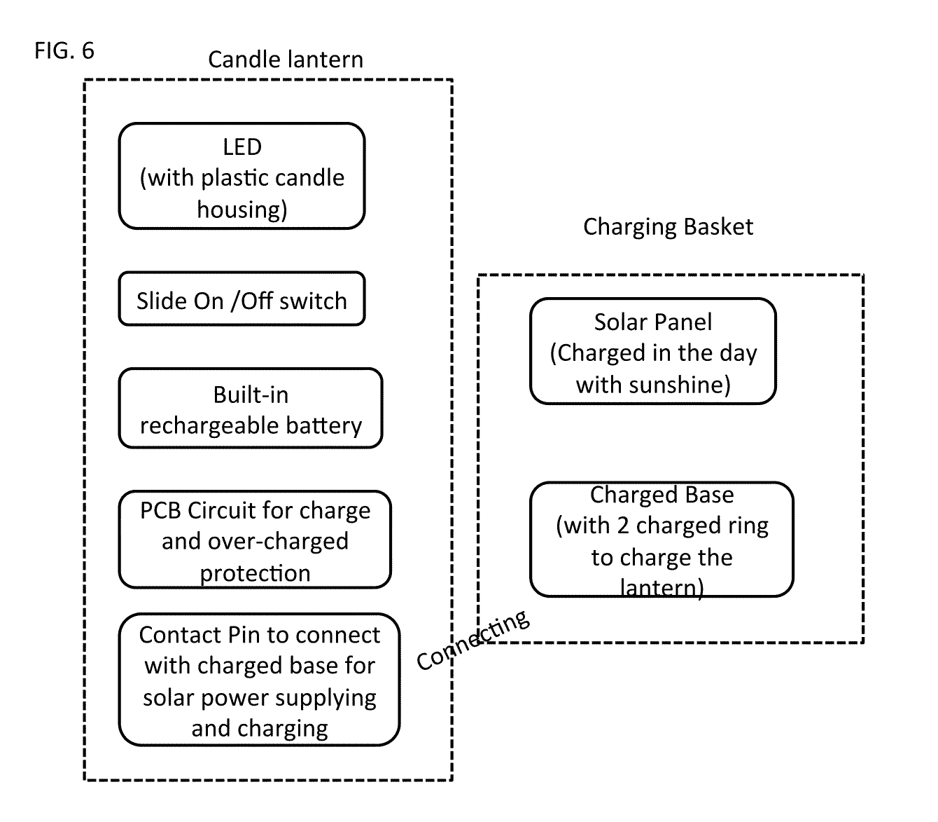

Referring to FIG. 6, in one preferred embodiment of the present invention, the system consists essentially of a candle lantern lamp and a solar charging basket. The candle lantern lamp consists essentially of a LED lamp having a cover and enclosed in a housing; a slide on/off switch on the bottom of the LED lamp, a built-in rechargeable battery, a PCB controller for charging by the solar panel and prevention of over charging, and a pair of contact pins connecting the charging base with the LED lamp and supplying solar energy to the rechargeable battery. The charging basket comprises a solar panel and two charging rings coupled with the base of the LED lamp.

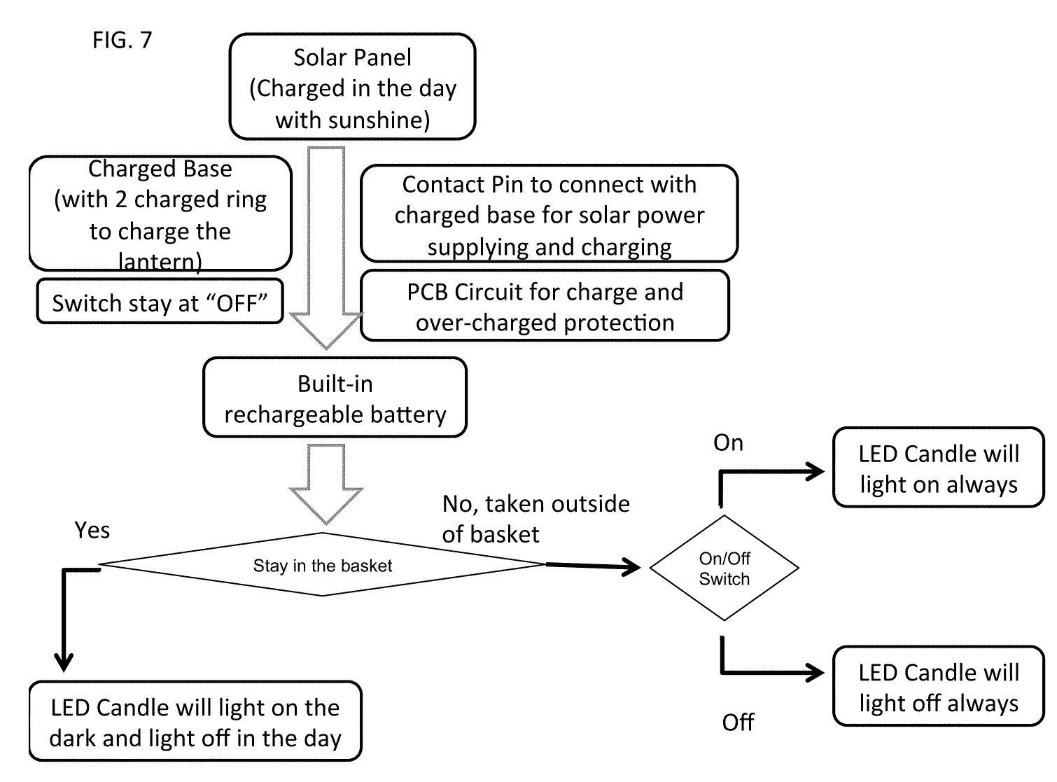

FIG. 7 further illustrates the working principle of the solar LED systems in accordance with the aspect of the present invention. In one embodiment, in the daylight, the lantern lamp is switched to OFF, the solar panel 1 collects solar energy and converts the solar energy to electrical energy; the electrical energy is charged into and reserved in the rechargeable battery 12 via the controller on the PCB 11. In nighttime, the rechargeable battery 12 provides electrical energy to the LED lamp 10 and the LED emits light. During the day the manual switch for the LED is switched OFF and in the nighttime, the manual switch for the LED is placed on ON.

The LED lamp has two different operational modes, a charging mode and an emission mode. In the charging mode, the LED lamp is placed inside the basket and is coupled to the charging base, whereas in the emission mode, the LED lamp can be either attached to the charging base inside the basket or be de-attached, as a stand alone unit placed outside of the basket.

The solar LED lamp in accordance with the present invention, further comprises a hanging means on top of the housing, allowing the LED lantern lamp to be hung or suspended from the top when the lamp is in the emission mode.

Further, as illustrated in the drawings, the solar LED lighting system in accordance with the present invention comprises 2, 3 or 4 LED solar lamps.

Although only a few embodiments of the present invention have been illustrated and described, it would be appreciated by those skilled in the art that changes may be made in these embodiments without departing from the principles and spirit of the invention. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein. As used in this disclosure, the term “preferably” is non-exclusive and means “preferably, but not limited to.” Terms in the claims should be given their broadest interpretation consistent with the general inventive concept as set forth in this description.

What is claimed is:

1. A solar lighting system, comprising
a solar panel, converting solar energy to charge a rechargeable battery;
a detachable lamp, comprising an LED, electrically connected to the rechargeable battery;
the rechargeable battery, placed on the base of the detachable lamp; and
a carrying vessel, wherein
the solar panel is permanently attached to at least one outer surface of the carrying vessel;
the carrying vessel is substantially hollow to allow the detachable lamp to easily enter and exit; and
the when the lamp is placed inside the carrying vessel the lamp is substantially exposed to the environment where the system resides.

2. The solar lighting system of claim 1, wherein the lamp further comprises a slide ON/OFF Switch.

3. The solar lighting system of claim 1, wherein the lamp further comprises a controller including a charging and over charge protection circuit.

4. The solar lighting system of claim 1, wherein the carrying vessel further comprises one or more charging seats.

5. The solar lighting system of claim 4, wherein each charging seat comprises at least a pair of charging rings.

6. The solar lighting system of claim 4, wherein the lamp further comprise a contact pin that electrically connects the battery and charging ring when the lamp is placed in the carrying vessel.

7. The solar lighting system of claim 4, wherein the base of lamp can be securely fasten to the charging seat.

8. The solar lighting system of claim 1, wherein the carrying vessel is substantially basket shaped.

9. The solar lighting system of claim 1, wherein the detachable lamp is substantially lantern shaped.

10. The solar lighting system of claim 1, wherein the LED is substantially candle shaped.

11. The solar lighting system of claim 1, wherein the carrying vessel further comprises a frame handle.

12. The solar lighting system of claim 11, wherein the frame handle is an inverted U shape.

13. The solar lighting system of claim 12, wherein the inverted U shaped handle has one horizontal component and two supporting components.

14. The solar lighting system of claim 5, wherein the solar panel is attached on the surface of the horizontal component.

15. The solar lighting system of claim 4, wherein the carrying vessel comprises two, three or four charging seats.

16. The solar lighting system of claim 9, wherein the lantern lamp further comprises a hanging means on the top of the lamp.

17. The solar light system of claim 9, wherein the lamp has a plastic housing.

18. The solar light system of claim 9, wherein the lamp has an ON/OFF swtich.
